(19) United States
(12) Patent Application Publication
(10) Pub. No.: US 2011/0137627 A1
(43) Pub. Date: Jun. 9, 2011

(54) METHOD AND SYSTEM FOR HOMOLOGOUS CONTROL OF NETWORKS

(76) Inventors: Domenico NAPOLETANI, Fairfax, VA (US); Michele Signore, Rome (IT); Timothy Sauer, Fairfax, VA (US); Lance Liotta, Bethesda, MD (US); Emanuel Petricoin, Gainesville, VA (US)

(21) Appl. No.: 12/959,096

(22) Filed: Dec. 2, 2010

Related U.S. Application Data
(60) Provisional application No. 61/265,815, filed on Dec. 2, 2009.

(51) Int. Cl. G06G 7/48; G06F 17/10

(52) U.S. Cl. 703/2; 703/11

(57) ABSTRACT

A system and method for creating at least one new network, comprising: selecting at least one node and at least one set of reactions where reagents in each reaction of the at least one set of reactions are known in at least one reference network; and creating at least one new network by causing the at least one new network to behave in a similar way with respect to the at least one node and the at least one set of reactions as the at least one reference network reacts with the at least one node and the at least one set of reactions.

### CROSS REFERENCE TO RELATED APPLICATIONS

This application claims priority from U.S. provisional patent application 61/265,815, filed on Dec. 2, 2009, the entirety of which is incorporated by reference.

### BRIEF DESCRIPTION OF THE DRAWINGS

FIG. 1 is a flowchart for creating a homologous new network;

FIG. 2 is a flowchart on how the adapted augmented reconstruction algorithm can be created;

FIGS. 3-6 illustrate reference networks where reactions to targets with inhibitors are used; and

FIG. 7 illustrates a system, where at least one homologous new network can be created from at least one reference network.

### DESCRIPTION OF EMBODIMENTS OF THE INVENTION

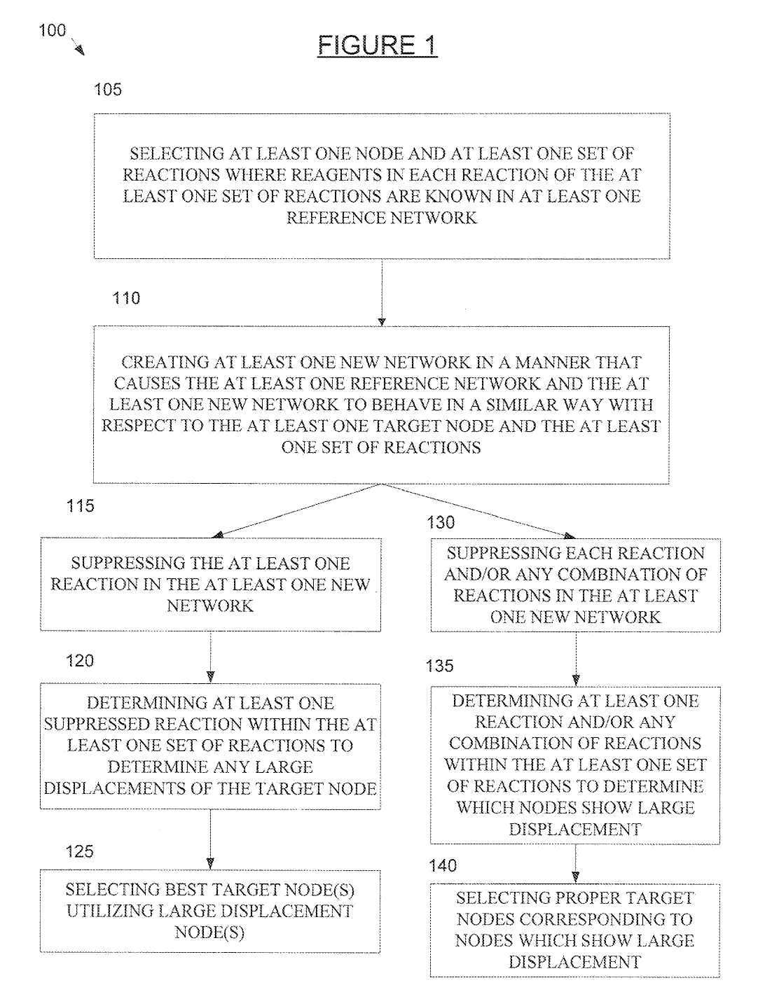

FIG. 1 illustrates a method 100 of creating at least one homologous (i.e., similar) new network created from at least one reference network, and how knowledge regarding how at least one set of inhibitors affects nodes in at least one similar new network helps determine at least one proper target node to utilize for the reference network, according to one embodiment. This can enable the ability to work with limited, noisy data and with reference networks that have a large number of nodes. It should be noted that this method 100 can be used for both complete networks and incomplete networks (e.g., where only a portion of the nodes are measured). It should also be noted that the reference network can be: a protein signaling network, a social network, an ecological network, a neuronal network; a metabolic network, a transcriptional network, a biological network, or a heterogeneous biological network; or any combination thereof.

For example, with respect to a protein signaling reference network, a new network can be created that is homologous to the large reference network in that kinase inhibition of several reactions can alter the trajectories of a sizable number of proteins in comparable ways for the reference network and the new networks. This can cause a nearly optimal combinatorial dosage of kinase inhibitors to be inferred in the reference network for many nodes from the new network. This can be utilized, for example, in a variety of applications in personalized medicine. Because variations in individuals' genetic profiles oftentimes correlate with differences in how individuals develop diseases and respond to treatment, personalized medicine has the potential to facilitate optimal risk identification, disease screening, disease diagnosis, therapy, or monitoring, or any combination thereof. In addition, proteomic signatures (e.g., protein signatures) and metabolic signatures (e.g., metabolite (e.g., lipids, carbohydrates) signatures) can hold great potential for serving as pillars of personalized medicine in guiding patient care.

As it is the proteins that form the actual cell signaling and metabolic networks within the cell, for some classes of molecular targeted inhibitors, it is the proteins that are the drug targets, not the genes. In addition, the molecular networks are underpinned by protein and protein phosphorylation. Therefore, for example, personalized medicine can be directed towards the generation of protein-based molecular maps of cancer networks in order to target malignant cells in their specific and unique context. The usefulness of patient-tailored therapy can come from the potential ability to depict patient-specific molecular circuitries and hence translate each targeted treatment in a favorable clinical response.

In addition, the ability to dynamically measure and collect enough data from every protein within networks with current methodologies would be helpful. The creation of a new network that projects the same network structure as the patient's network (the reference network), for each protein, to trajectories that are qualitatively similar, can be useful. In one embodiment, this can be useful even when the details of the topology of the connections among nodes differ in the reference network and the new network.

In one embodiment, the problem of controlling protein signaling networks can seek the inhibition of specific reactions that are believed to regulate signaling networks involved in cancer development. Moreover, the trajectories for each node can be generated by stimulation of cell lines and subsequent relaxation to steady state, so that the extent of suppression of a protein activity can be determined by looking at the maximum value of a relatively simple curve. This maximum value can indicate that there is a strong correlation between specific cell functions (e.g., proliferation, death, etc.) and the concentration of some known proteins, and therefore change (e.g., suppression/enhancement) of the activity of specific proteins can be seen as a proxy for the final goal of disrupting the functioning of cancer cells.

In one embodiment, the ability to predict the sensitivity of cancer cells to the inhibitions of multiple reactions can allow prediction of use of a combination of drugs in order to achieve synergy and/or potentiation of several orders of magnitude, while avoiding undesired effects on normal cells. One goal of the combinatorial approach to cancer therapy is the control of the activity of specific proteins in the network. Using the reference network and the new network, it can be determined how close the two networks will react, for specific nodes, to similar control schemes. In one embodiment, this comparison can be made on very long time scales, for example, on time intervals where the networks have each related to the steady state, so that the comparison of the networks can be considered global.

As described below, in one embodiment, augmented sparse reconstruction can generate artificial new networks that are homologous to the reference network, in the sense that kinase inhibition of several reactions in the new network can alter the trajectories of a sizable number of proteins in comparable ways. The optimal combinatorial dosage of kinase inhibitors can then be inferred in many cases from the new network. This information can help reduce the experimental load necessary to find near-optimal combinations of kinase inhibitors for a list of potential target reactions.

Referring again to FIG. 1, 105-110 illustrate how the new network(s) is created. In 105, at least one node and at least one set of reactions is selected, where reagents in each reaction of the at least one set of reactions are known in at least one reference network. For example, the node can be a protein and the set of reactions can be a set of kinase inhibitor reactions, where the reagents affected by the set of kinase inhibitors are known in the reference network, which can be any signaling pathway network.

In one embodiment, an epidermal growth factor receptor (EGF-R) network can be the signaling pathway network. The EGF-R family is a family of four structurally related receptor tyrosine kinases (e.g., ErbB receptors). Signals from the ErbB receptors can represent a versatile and conserved group of molecules and interactions. The amplitude of EGF-R cascades can reach high levels within minutes of stimulus and the recycling mechanism of receptor molecules after signal transduction can cause the system to relax back to steady state in absence of EGF molecules. The four human ErbB receptors can induce a wide variety of cellular responses, thereby generating a complex response in the protein interaction network.

The EGF-R network can also be helpful because improved strategies to integrate anti-EGF-R agents (e.g., in order to suppress protein activity) with conventional therapies and to explore combinations with other molecular targets can be useful. Referring back to FIG. 1, in 110, at least one new network can be created in a manner that causes the reference network and the new network to behave in a similar way with respect to the selected node(s) and the selected set(s) of reactions. It should also be noted that, in one embodiment, similarity can be defined as the concordance of the relative magnitude of the maximum difference of the trajections of the nodes N, starting from equal initial conditions. For example, if the reference network is the EGF-R signaling pathway network, the new network can be created by assuming the new network will behave in a similar way with respect to the selected protein and the selected set of kinase inhibitor reactions. In one embodiment, the reference network can be simulated by using at least one differential equation model of the EGF-R signaling pathway network put forth in B. Schoeberl et al., Computational modeling of the dynamics of the MAP kinase cascade activated by surface and internalized EGF receptors, Nat. Biotechnol. 20: 370-375 (2002) and J. J. Hornberg et al., Control of MAPK signaling: from complexity to what really matters, Oncogene 24, 55335542 (2005), which are both herein incorporated by reference. In this case, the new network model can be assumed to have only linear and quadratic terms in the representation of the derivative of the activity of each node of the network. Linear terms can correspond to uni-molecular interactions and quadratic terms can correspond to bi-molecular interactions. It should be noted that more complex terms can be assumed to model more complex molecular interactions. The new network created using this model can be a large network, which can be useful as the reference networks (i.e., the networks of interest) are often large. In the example EGF-R signaling pathway network used in one embodiment of the invention, the differential equation model can be formally integrated and modified to lead to the following model:

$${z}_{n} ( t ) - {x}_{n} ( {t}_{0} ) = {a}_{0 n} + {\sum }_{t = 1}^{N} {l}_{i n} {\int }_{{t}_{0}}^{t} {x}_{t} d t + {β}_{q} {\sum }_{i = 1}^{N} {\sum }_{j = 1}^{N} {q}_{ijn} {\int }_{{t}_{0}}^{t} {x}_{i} {x}_{j} d t + {\sum }_{g = 1}^{C} {w}_{gn} {n}_{g} . \qquad Equation ( 1 )$$

Equation (1) can illustrate the model of the new network at a node n, in a specific integral form that can be used in augmented sparse reconstruction. In one embodiment, Equation (1) can be defined as the integral of a differential equation with linear and quadratic terms, and with added random terms to make sure the reconstruction algorithm is able to eliminate errors in variables due to the presence of non-linear terms. In Equation (1), B_{q}≦1 can represent positive attenuation coefficients for the quadratic terms (in one embodiment, this can also be input by the user). The system's parameters at node n that can be determined can be: a₀ₙ, lᵢₙ (where i=1, . . . , N), and qᵢⱼₙ (where i, j=1, . . . , N). The n_{g} (where g=1, . . . , G) are discrete random vectors normally distributed, scaled to have norm 1 and multiplied by suitable parameters w_{gn} to be determined together with the system parameters. The xᵢ, xⱼ and xₙ can be phosphorylated proteins, and t can be time.

Equation (1) can assume that specific reactions must be present in the reconstruction of the network, since homologous systems are defined with respect to the action of kinase inhibitors.

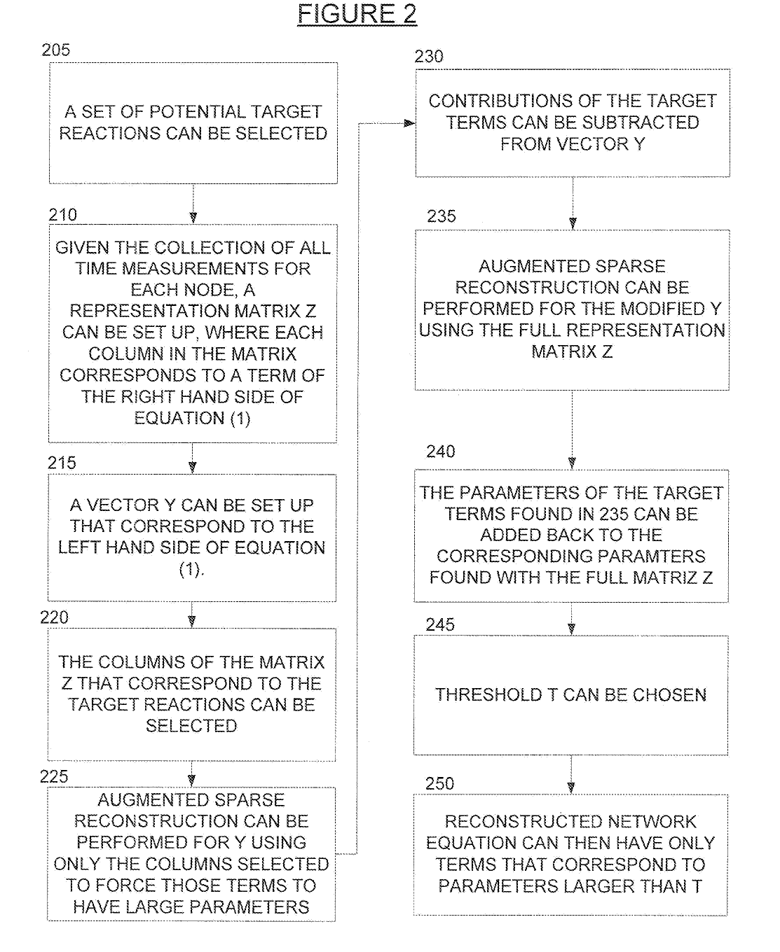

Equation (1) can be adapted to guarantee the presence of specific reactions for a target node with a set of inhibitors (e.g., a set of available kinase inhibitors). (FIG. 2 sets forth details on how the adapted augmented reconstruction algorithm can be created, according to one embodiment.)

It should be noted that, in other embodiments, other equations can be used instead of Equation (1). For example, power function terms can be input in Equation (1).

After 110, either at least one selected reaction can be suppressed in the new network, as illustrated in 115-125, or all reactions can be suppressed in the new network, as illustrated in 130-140.

In 115, the selected reaction(s) can be suppressed in the new network. For example, for a set of kinase combinations, for each kinase combination, trajectories for a variety of biologically meaningful initial conditions can be generated. In 120, it can be determined if there are any large displacements of the selected suppressed reaction(s). In 125, at least one proper target node to utilize (e.g., for more testing) can be selected utilizing any large displacements that are found.

In 130, each reaction and/or each combination of reactions in the at least one new network can be suppressed. In 135, it can be determined if there are any large displacements of the suppressed reaction and/or combination of reactions. In 140, a proper target node(s) to utilize (e.g., for more testing) can be selected utilizing any reaction or combination of reactions that causes large displacements in the target nodes.

FIG. 2 sets forth details on how the adapted augmented reconstruction algorithm can be created, according to one embodiment. It should be noted that, in one embodiment, Equation (1) can be the starting point. In 205, a set of potential target reactions vₛ=aₛxᵢ_{ₛ}xⱼ_{ₛ}−bₛxₖ_{ₛ} (where s=1, . . . , S) can be selected. This can show that phosphorylated proteins xᵢ_{ₛ} and xⱼ_{ₛ} are interacting to phosphorylate protein xₖ_{ₛ}, and in the process they can get de-phosphorylated. It should be noted that xᵢ_{ₛ}=fᵢ_{ₛ} (x1, . . . , xn), which can represent the derivative of the phosphorylated concentration of proteins xᵢ_{ₛ} (and similarly xⱼ_{ₛ} and xₖ_{ₛ}) as a function of the state of (possibly) all proteins. Note that aₛ and bₛ can be kinase inhibitors with nonzero parameters.

In 210, given the collection of all time measurements for each node variable n a representation matrix Z can be set up, where each column in the matrix Z corresponds to a term of the right hand side of Equation (1) (e.g., constant, linear, quadratic and random). In 215, a vector Yₙ can be set up that corresponds to the left hand side of Equation (1). In 220, the columns of Z that correspond to the target reactions involved in the activity of the given node n can be selected. In 225, augmented sparse reconstruction can be performed for Yₙ using only the columns selected in 220 to force those terms to have large parameters in the overall representation. In 230, the contribution of the target terms can be subtracted from the vector Yₙ. In 235, augmented sparse reconstruction can be performed for the modified Yₙ using the full representation matrix Z. In 240, the parameters of the target terms found in 235 can be added back to the corresponding parameters found with the full matrix Z. In 245, a threshold Tₙ can be chosen. In 250, the reconstructed network equation for node n can then have only linear and quadratic terms that correspond to parameters larger than Tₙ.

As noted above, in one embodiment, the algorithm found in 250 can be a modification of the algorithm in Equation (1), where, for each protein, a preliminary augmented sparse reconstruction can be performed only on the terms that are related to the reactions selected as potential kinase targets, if they have an impact on that protein. After this preliminary step, a full augmented sparse reconstruction can be performed with all potential linear and quadratic terms. Note that, in one embodiment, a full model can be output from the algorithm found in 250.

The following is an example of the process of FIG. 2: For each node variable n (from a set of node variables from a network where n=1, . . . , N), it is possible to generate R trajectories X_{n,r}, where r=1, . . . with different initial conditions, uniformly sampled at L points. In one embodiment, to build the left hand side of Equation (1) and the individual terms in the right hand side of Equation (1), X̅_{n,r} can be the vector X_{n,r}(t)−X_{n,r}(t₀), where t takes all L sampled values. For a given vector g(t) (where t=t₀, . . . , t_{L}), let I(g) be the vector whose l-th component is the sum Σᵢ₌₀^{l}g(tᵢ). In addition, let Yₙ=[ X̅_{n,1}, . . . , X̅_{n,R}], Gₙ=[I(X_{n,1}), . . . , I(X_{n,R})] (where n=1, . . . , N), and Gᵢⱼ=[I(X_{i,1}Xj,1), . . . , I(X_{i,R}X_{j,R})]. Also let J denote the unit vector with the same length as Yₙ.

An attenuation coefficient β_{q} can be chosen for the quadratic terms Gᵢⱼ. Let n_{g} (where g=1, . . . , G) be discrete random vectors normally distributed and scaled to have norm 1. The 2-norm of a vector can be denoted by ∥, and Ĝ₁ can be the matrix whose columns are all the vectors

$$\frac{{G}_{i}}{\vert {G}_{i} \vert} ,$$

and Ĝ_{q} can be the matrix whose columns are all possible vectors

$$\frac{{G}_{ij}}{\vert {G}_{ij} \vert} , .$$

Let N_{G} be the matrix whose columns are the random vectors n_{g} scaled to have norm 1. Choose G large enough to have the matrix Z=[JĜ₁, β_{q}Ĝ_{q}, N_{G}] with small condition numbers (e.g., less than 102).

A temporary representation matrix M, for each s=1, . . . , S, can be set if the node n belongs to the set {iₛ, jₛ, kₛ}, and the vectors

$$\frac{{G}_{{k}_{s}}}{\vert {G}_{{k}_{s}} \vert} and \frac{{G}_{{i}_{s} {j}_{s}}}{\vert {G}_{{i}_{s} {j}_{s}} \vert}$$

can be added as columns to the matrix M.

Then, let Z_{M}=[M N_{G}]. Find the minimal l₁ solution to the underdetermined system Yₙ=Z_{M}σ_{M}. (Note that σ_{M} can be the restriction of σ to the columns of M, and Yₙ can be set equal to Yₙ−Mσ_{M}).

Then, the minimal l₁ solution to the underdetermined system Yₙ=Zσ can be found. If a nonzero matrix M was generated above, then the components of a associated to the columns of M can be added to the corresponding components of σ_{M}.

The threshold can be Tₙ and σ_{T}_{ₙ} can be the coefficients, with σ larger than Tₙ. Thus, in the example, the reconstructed network equation for xₙ can have only linear and quadratic terms that correspond to coefficients in σ_{T}_{ₙ}, and their coefficients can be the coefficients of σ_{T}_{ₙ} divided by the norm of the corresponding |Gᵢ|, if a linear term, and |Gᵢⱼ| if a quadratic term. It should be noted that there can be considerable flexibility in the choice of the number G of random terms and in the choice of the attenuation coefficient β_{q}.

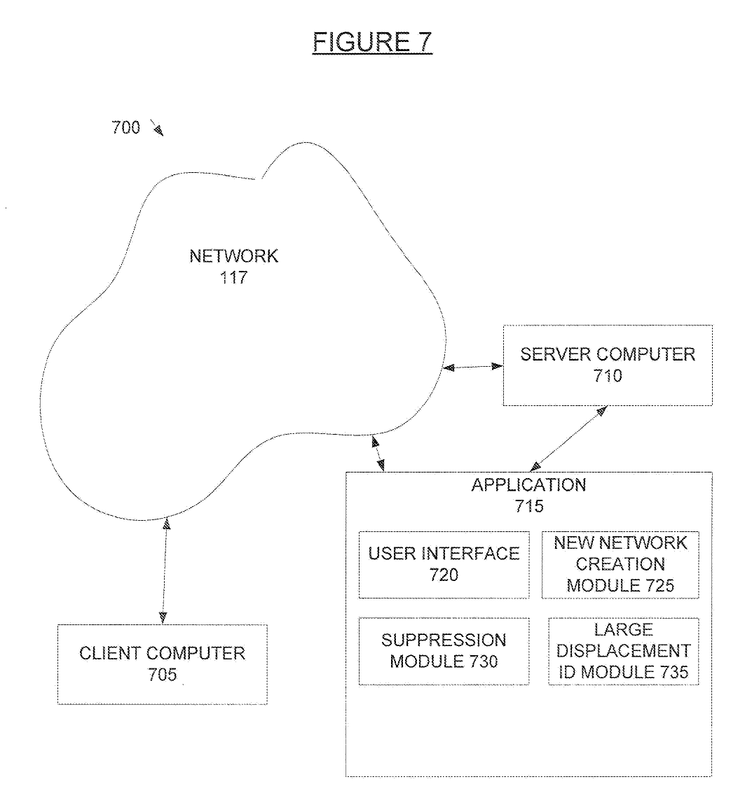

FIG. 7 illustrates a system 700, where at least one homologous (i.e., similar) new network can be created from at least one reference network, and how knowledge regarding how at least one set of inhibitors affect nodes in at least one similar new network can help determine at least one proper target node to utilize for the reference network, according to one embodiment. System 700 can include: at least one client computer 705 connected to at least one server computer 710 and/or at least one application 715 over at least one network 717. The application 715 can comprise at least one user interface 720, at least one new network creation module 725, at least one suppression module 730, or at least one large displacement identification module 735, or any combination thereof. The user interface 720 can accept input from at least one user, which input can comprise: at least one node, at least one set of reactions, or at least one set of terms (e.g., linear, quadratic, power function), at least one attenuation coefficient, or any combination thereof. The new network creation module 725 can comprise logic to perform some or all of 205-250 of FIG. 2. The suppression module 730 can suppress reactions. For example, reactions to suppress can be chosen and entered by the user using the user interface, or all or the reactions and/or some and/or all combinations of the reactions can be suppressed. The large displacement identification module 735 can determine which of the suppressions caused the largest displacements. Those of ordinary skill in the art will see that there are many other ways to set us system 700, and that some or all of the modules described herein, and/or additional modules, can be used.

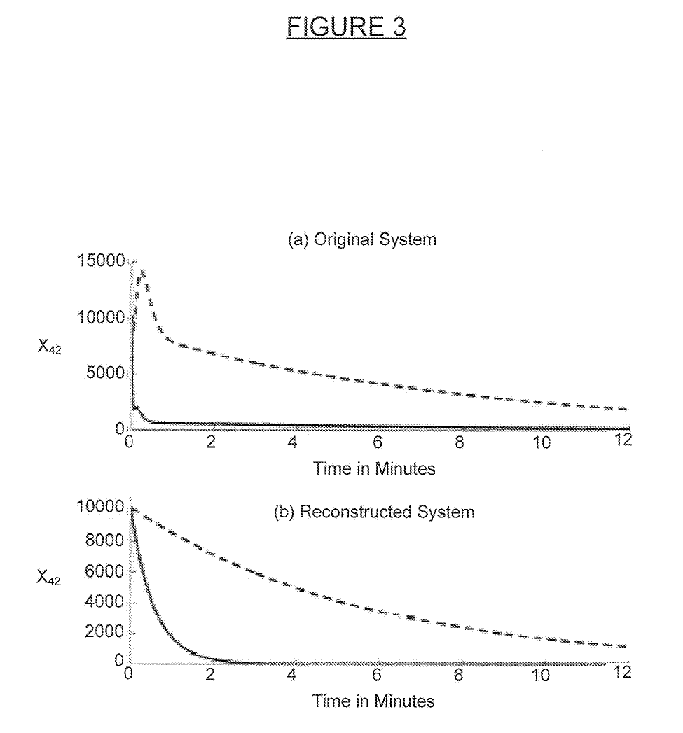

FIGS. 3-6 illustrate several reference networks and new networks, according to several embodiments. In each of these reference networks, there can be 50 different noisy initial conditions, and each trajectory can be sampled at 11 points in time, with time measured in minutes. This interval can be acceptable because, after this point, in some embodiments, most nodes can relax back to their steady state. The noise level for each trajectory is assumed to be at most 10% of the mean value of the points along the trajectory itself. This setting can give 550 (50×11) data points for each of the 103 nodes in the network. It should be noted that smaller numbers of data points per node are possible.

Initial conditions must also be chosen to be able to determine displacements in the new network. The copy numbers (i.e., number of protein molecules in the cell) of the individual proteins can vary enormously, and protein concentration can vary with cell type and cell cycle stage. In FIGS. 3-6, the initial conditions for the reference networks can be chosen to be random values uniformly distributed in the interval [2000, 20000], which can represent the average number of copies of molecules per cell. The average number of EGF receptors can be a random value in the interval [1000, 10000]. EGF can be selected to be a random value in the interval [10⁻⁸, 10⁻⁷], and can be a compound outside the cell measured in gr/ml. It should be noted that, in some embodiments, other choices can be made for the initial conditions, the average number of EGF receptors, and EGF. The above choices can reflect two assumptions: strong variability of trajectories, and measurable dynamical changes. Selecting relatively small values for the nodes in the initial conditions can allow for dynamical trajectories that are sufficiently varied. However, in some embodiments, larger values can be utilized.

FIGS. 3-6 illustrate reference networks where 19 reactions to targets with inhibitors are used. The 19 reactions can be chosen on the basis of their position along the EGF-R signaling cascade, in order to comprise both upstream and downstream molecular events that span the entire signal transduction cascade from top (e.g., EGF-R docking sites) to bottom (e.g., MEK or ERK phosphorylarion). These reactions can be: v19, v66; v20, v67; v23, v70; v27, v74; v29, v76; v41, v83; v45, v87, v47, v89; v55, v97; and v60. Given this selection of reactions for kinase inhibition, the ability of the new network to mirror the reference network, can be determined. The degree of concordance of the maximum pointwise distance between trajectories with the same initial conditions and with controls on and off, respectively, can be determined. The maximum distance can be divided by the maximum value of the trajectory of the reference system to obtain a scaled maximum displacement of trajectories due to control.

FIG. 3 illustrates a case of concordance of scaled maximum displacement, according to one embodiment. The top plot illustrates the change in behavior of node 42 of the reference EGF-R network when reactions v29 and v66 are inhibited with κ=0.1 (the kinase inhibitor coefficient). The bottom plot shows the corresponding change of behavior for the 42nd node of the new network. Note that, in both plots, the dashed curves can be trajectories with inhibitors on, while solid curves can be trajectories without inhibitors. Note that, in this case, the long term behavioral change is similar, but the new system misses the initial details of the dynamics. In some other cases, the opposite may be true, as the initial dynamics may be reconstructed accurately, while the new system may fail to capture the long term dynamics. Those of ordinary skill in the art will see that other patterns may be possible. In one embodiment, the goal is not exact trajectory reconstruction, but only an estimate of how the trajectory is changing when the inhibitors are switched on.

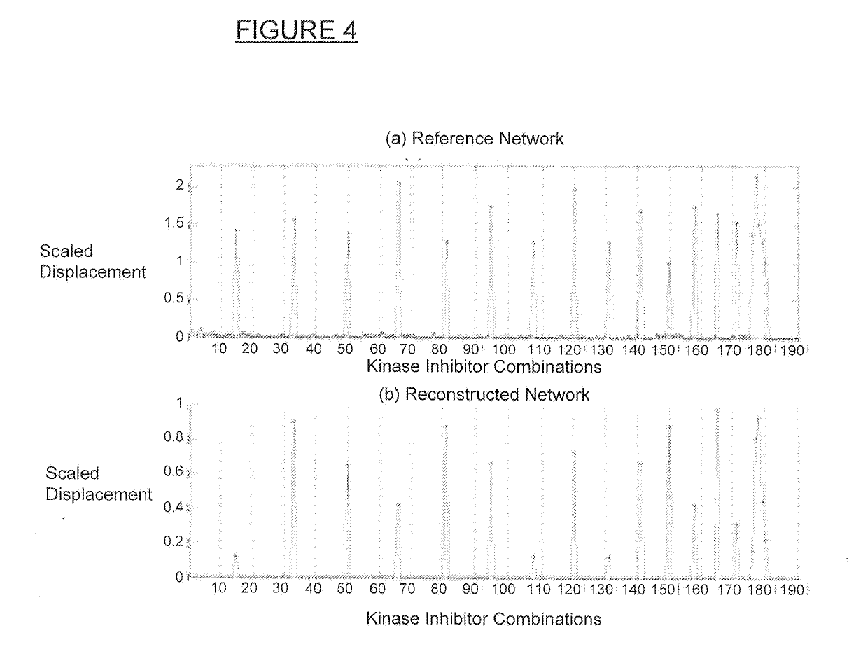

FIG. 4 illustrates the magnitude of the median scaled displacement of a node, according to one embodiment. In this embodiment, the median is measured instead of the mean because many times the scaled displacement has very similar behavior, but sometimes a small number of initial conditions that lead to divergent trajectories for some nodes in the new system make the mean too sensitive to these outliers. FIG. 4 plots the magnitude of the median scaled displacement of node 70 with respect to the set of 190 different kinase inhibitor coefficients where each κₛ (where s=1, . . . , 19) is allowed to be either 1 (no inhibition) or 0.1 (high kinase inhibition). Each point of the horizontal axis corresponds to one among 190 different pairs of kinase inhibitor combinations. In some embodiments, one and/or two reactions at a time can be inhibited. However, more than two reactions can also be inhibited in some embodiments. It should be noted that knowledge of target profiles can help careful evaluation as to which drug or drug combinations should be used as inhibitors to better exploit each drugs full potential.

Note that FIG. 4 has a striking concordance of the shape of the reference network (the top plot) and the new network (the bottom plot). This can suggest that the optimal combination of kinase coefficients can be inferred from the scaled displacement curve of the new network.

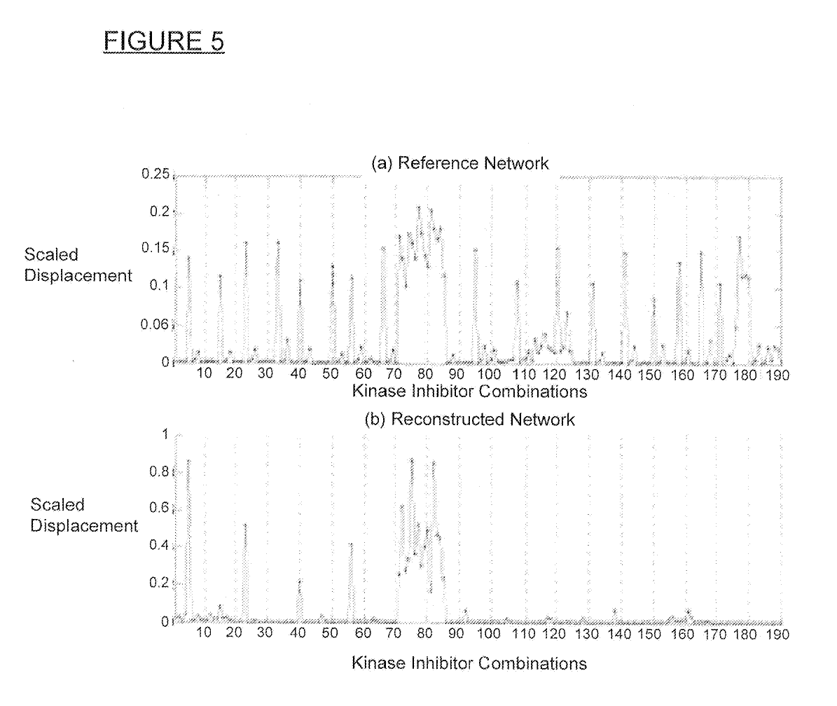

FIG. 5 illustrates one embodiment of a reference network and a new network, where the displacement curves tend to agree only partially and only when there is large displacement. In FIG. 5, the top plot is the reference network, and the bottom plot is the new network, both with respect to node 41. Each point of the horizontal axis corresponds to one among 190 different pairs of kinase inhibitor combinations. Concordance can be seen for many (but not all) high displacement values relative to node 41. The displacement curve of the new network can help identify the combination of kinase inhibitors that has the highest impact on node 70.

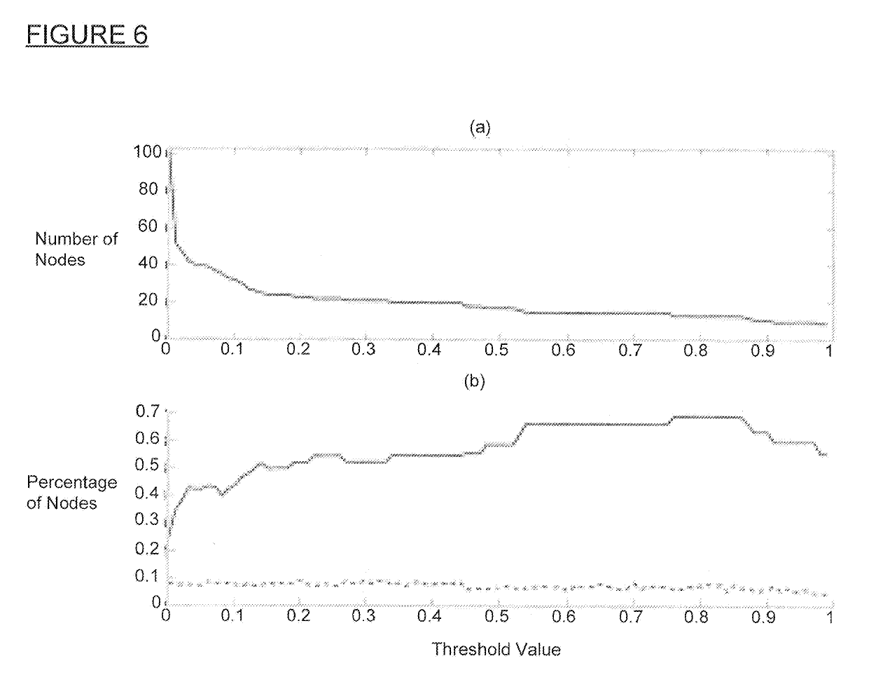

FIG. 6 illustrates effectiveness of the method described in FIGS. 1-2, according to one embodiment. Plot (a) shows the number of nodes of the new network that have the maximum of their scaled displacement curve above the threshold values given on the horizontal axis. The solid line in plot (b) shows the percentage of such nodes for which near-optimal kinase inhibitor combinations can be predicted. Achievement of near optimality can be verified, for example, when the locations of the top three maxima of scaled displacements of the reconstructed network are such that for at least one of them, the reference network has scaled displacement that is 70% of the absolute maximum. Percentages can be plotted with respect to the threshold on the maximum value of the scaled displacement curves. The dashed line in plot (b) shows the percentage of nodes for near-optimal kinase inhibitor combinations when the position of the scaled displacements of the reconstructed network has been randomly permutated. FIG. 6 thus illustrates that near-optimality for a random scrambling of the data can be very low. However, for nodes with large displacement, the method described in FIGS. 1-2 can be more accurate in finding near-optimal combinations. This presents potential savings, due to the data-based narrowing of combinatorial possibilities, in the search for appropriate kinase therapies.

While various embodiments of the present invention have been described above, it should be understood that they have been presented by way of example, and not limitation. It will be apparent to persons skilled in the relevant art(s) that various changes in the form and detail can be made therein without departing from the spirit and scope of the present invention. Thus, the invention should not be limited by any of the above-described exemplary embodiments.

In addition, it should be understood that the figures described above, which highlight the functionality and advantages of the present invention, are presented for example purposes only. The architecture of the present invention is sufficiently flexible and configurable, such that it may be utilized in ways other than that shown in the figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method for creating at least one new network, comprising:
selecting at least one node and at least one set of reactions where reagents in each reaction of the at least one set of reactions are known in at least one reference network; and
creating at least one new network by causing the at least one new network to behave in a similar way with respect to the at least one node and the at least one set of reactions as the at least one reference network reacts with the at least one node and the at least one set of reactions.

2. The method of claim 1, wherein the at least one node is at least one target node.

3. The method of claim 2, further comprising:
suppressing at least one reaction of the at least one new network;
determining at least one reaction within the at least one set of reactions of the at least one new network that changes activity of the at least one target node; and
determining displacement size of the changed activity.

4. The method of claim 3, further comprising:
changing the activity of at least one target node in the at least one reference network.

5. The method of claim 2, further comprising:
suppressing at least one reaction and/or any combination of reactions within the at least one set of reactions in the at least one new network; and
determining at least one reaction and/or any combination of reactions that cause relatively large displacement of the change of the at least one target node.

6. The method of claim 1, wherein the at least one reference network is at least one protein signaling pathway network.

7. The method of claim 6, wherein the at least one node is at least one protein and/or the at least one set of reactions are at least one set of kinase inhibitor targets.

8. The method of claim 6, wherein the at least one protein signaling pathway network is at least one epidermal growth factor receptor (EGF-R) signaling pathway network.

9. The method of claim 8, wherein the at least one new network is at least one differential equation model of the EGF-R signaling pathway network.

10. The method of claim 9, wherein the differential equation model is at least one model derived by an adaptive recursive augmented sparse reconstruction algorithm.

11. The method of claim 9, wherein the differential equation model is integrated and modified to obtain the following equation for each node activity:
$${z}_{n} ( t ) - {x}_{n} ( {t}_{0} ) = {a}_{0 n} + {\sum }_{t = 1}^{N} {l}_{i n} {\int }_{{t}_{0}}^{t} {x}_{t} d t + {β}_{q} {\sum }_{i = 1}^{N} {\sum }_{j = 1}^{N} {q}_{ijn} {\int }_{{t}_{0}}^{t} {x}_{i} {x}_{j} d t + {\sum }_{g = 1}^{C} {w}_{gn} {n}_{g} .$$

12. The method of claim 7, wherein knowledge regarding how the at least one set of kinase inhibitors affects all proteins in the at least one new target helps determine at least one proper target protein for the at least one reference network.

13. The method of claim 1, wherein at least one relative maximum displacement for the at least one reference network corresponds to at least one relative maximum displacement for the at least one new network, and wherein the corresponding suppressed reactions are determined to be suitable to change the target protein for the at least one reference network.

14. The method of claim 1, wherein the at least one reference network is a social network, or an ecological network, or a neuronal network or a metabolic network, or a transcriptional network, or a biological network, or an heterogeneous biological network; or any combination thereof.

15. The method of claim 1, wherein the at least one reference network has limited, noisy data and/or has a large number of nodes.

16. The method of claim 11, wherein the equation is modified while retaining the known reactions' structure to obtain at least one new network equation that is used to create the at least one new network.

17. The method of claim 16, wherein the equation is modified several times with different choices of terms.

18. The method of claim 1, wherein the at least one reference system is any multi-scale system where genomic, proteomic and metabolic compounds are related in a single network.

19. The method of claim 2, further comprising:
enhancing at least one reaction of the at least one new network;
determining at least one reaction within the at least one set of reactions of the at least one new network that changes activity of the at least one target node; and
determining displacement size of the changed activity.

20. The method of claim 2, further comprising:
enhancing at least one reaction and/or any combination of reactions within the at least one set of reactions in the at least one new network;
determining at least one reaction and/or any combination of reactions that cause relatively large displacement of the change of the at least one target node.

21. A system for creating at least one new network, comprising:
at least one processor configured for:
selecting at least one node and at least one set of reactions where reagents in each reaction of the at least one set of reactions are known in at least one reference network; and
creating at least one new network by causing the at least one new network to behave in a similar way with respect to the at least one node and the at least one set of reactions as the at least one reference network reacts with the at least one node and the at least one set of reactions.

22. The system of claim 21, wherein the at least one node is at least one target node.

23. The system of claim 22, wherein the at least one processor is further configured for:
suppressing at least one reaction of the at least one new network;
determining at least one reaction within the at least one set of reactions of the at least one new network that changes activity of the at least one target node; and
determining displacement size of the changed activity.

24. The system of claim 23, wherein the at least one processor is further configured for:
changing the activity of at least one target node in the at least one reference network.

25. The system of claim 22, wherein the at least one processor is further configured for:
suppressing at least one reaction and/or any combination of reactions within the at least one set of reactions in the at least one new network; and
determining at least one reaction and/or any combination of reactions that cause relatively large displacement of the change of the at least one target node.

26. The system of claim 21, wherein the at least one reference network is at least one protein signaling pathway network.

27. The system of claim 26, wherein the at least one node is at least one protein and/or the at least one set of reactions are at least one set of kinase inhibitor targets.

28. The system of claim 26, wherein the at least one protein signaling pathway network is at least one epidermal growth factor receptor (EGF-R) signaling pathway network.

29. The system of claim 28, wherein the at least one new network is at least one differential equation model of the EGF-R signaling pathway network.

30. The system of claim 29, wherein the differential equation model is at least one model derived by an adaptive recursive augmented sparse reconstruction algorithm.

31. The system of claim 29, wherein the differential equation model is integrated and modified to obtain the following equation for each node activity:
$${z}_{n} ( t ) - {x}_{n} ( {t}_{0} ) = {a}_{0 n} + {\sum }_{t = 1}^{N} {l}_{i n} {\int }_{{t}_{0}}^{t} {x}_{t} d t + {β}_{q} {\sum }_{i = 1}^{N} {\sum }_{j = 1}^{N} {q}_{ijn} {\int }_{{t}_{0}}^{t} {x}_{i} {x}_{j} d t + {\sum }_{g = 1}^{C} {w}_{gn} {n}_{g} .$$

32. The system of claim 27, wherein knowledge regarding how the at least one set of kinase inhibitors affects all proteins in the at least one new target helps determine at least one proper target protein for the at least one reference network.

33. The system of claim 21, wherein at least one relative maximum displacement for the at least one reference network corresponds to at least one relative maximum displacement for the at least one new network, and wherein the corresponding suppressed reactions are determined to be suitable to change the target protein for the at least one reference network.

34. The system of claim 21, wherein the at least one reference network is a social network, or an ecological network, or a neuronal network or a metabolic network, or a transcriptional network, or a biological network, or an heterogeneous biological network; or any combination thereof.

35. The system of claim 21, wherein the at least one reference network has limited, noisy data and/or has a large number of nodes.

36. The system of claim 21, wherein the equation is modified while retaining the known reactions' structure to obtain at least one new network equation that is used to create the at least one new network.

37. The system of claim 36, wherein the equation is modified several times with different choices of terms.

38. The system of claim 21, wherein the at least one reference system is any multi-scale system where genomic, proteomic and metabolic compounds are related in a single network.

39. The system of claim 22, further comprising:
enhancing at least one reaction of the at least one new network;
determining at least one reaction within the at least one set of reactions of the at least one new network that changes activity of the at least one target node; and
determining displacement size of the changed activity.

40. The system of claim 22, further comprising:
enhancing at least one reaction and/or any combination of reactions within the at least one set of reactions in the at least one new network;
determining at least one reaction and/or any combination of reactions that cause relatively large displacement of the change of the at least one target node.
